(19) United States
(12) Patent Application Publication
(10) Pub. No.: US 2014/0068406 A1
(43) Pub. Date: Mar. 6, 2014

(54) FLUID USER MODEL SYSTEM FOR PERSONALIZED MOBILE APPLICATIONS

(71) Applicant: BRIGHNOTES LLC, Dallas, TX (US)

(72) Inventor: Shoshana Loeb Kornacki, Dallas, TX (US)

(73) Assignee: BrighNotes LLC, Dallas, TX (US)

(21) Appl. No.: 13/763,111

(22) Filed: Feb. 8, 2013

Related U.S. Application Data
(60) Provisional application No. 61/696,359, filed on Sep. 4, 2012.

(51) Int. Cl. G06F 17/24

(52) U.S. Cl. CPC G06F 17/241
USPC 715/230

(57) ABSTRACT

In described embodiments, fluid user models are employed for personalized mobile applications, referred to herein as recommender systems. The described embodiments augment media with additional information highly personalized to a user based on a variety of factors with different time sensitivity and include, but are not limited to, a user's general preferences, history, immediate context and attention, and emotional states when the user experiences and/or interacts with the media. Embodiments solve various problems of information overload stemming from both i) the complexity in characterizing the information and ii) its potential relevancy and in understanding and coding the user's needs.

### CROSS-REFERENCE TO RELATED APPLICATIONS

This application claims the benefit of the filing date of U.S. provisional application No. 61/696,359, filed on Sep. 4, 2012 as attorney docket no. 311.014Prov, the teachings of which are incorporated herein by reference.

### BACKGROUND

1. Field of the Invention

The present invention relates to media augmentation, and, in particular, to automatic media augmentation by fluid user models for personalized mobile applications.

2. Description of the Related Art

Media is embedded into our daily life. Research has consistently shown that an ever increasing portion of our time is spent using various forms of media. Multi-tasking of user media has become a regular everyday activity, and for a growing number of users, a user consuming media occurs alongside a user producing the media. Recently, proposals center on the proposition that, in order to understand our relationship with the various media, users should consider themselves “living in” rather than “living with” media. The media we live in is both interconnected and multi-modal, so intertwined and often invisible within our lives that the meaning that it takes is highly time and context sensitive.

This emersion of users in the media of any kind (e.g., music, news, music, and video), increases the possibility of over-exposure and information overload, which has been a recognized problem in the past, but dealing with such a problem is now becoming critical. Although recommendation engines and other information filtering tools have been developed over the last few decades, several fundamental technical issues remain.

Mobile applications, almost from the start, have taken into account user location information, as well as other sensor and context data, to better fit information that is delivered to the user according to the user's perceived needs, localized search results, context aware reminders and other task and calendar related activities. Adding context and time improves the results. Furthermore, research on how user emotions and moods affect choices were studied in specific cases and used to further prevent overexposure to information.

However, although these additional considerations help to eliminate some of the clutter of information overload by providing users with more targeted information, the problem of information overload still has not been addressed a completely satisfactory manner in many application areas.

The critical need to provide ways to protect the users from information overload has been widely recognized. The source of the problem is not just the ubiquity of the media but also the fact that, in general, people's attention resources are limited. These limitations are well characterized and need to be accounted for when modeling user's interactions with information and with others. For example, in Microsoft Research's Attentional User Interface project, human attention resources have been treated as a central construct and organizing principle.

The following media augmentation example of FIG. 1 shows how the dynamic nature of the user model might be addressed using current approaches.

FIG. 1 illustrates a scenario when a user is watching a video segment of a comedy show. As shown, a scenario 100 includes a media display device 104 (e.g., a TV or the like) that displays the video segment of the comedy show and an electronic display device 106 (e.g., iPad or the like, which has a second screen) that is running a media augmentation service while the user 102 is watching the show. As shown, around 28 minutes of the episode, an annotation is popped up on the user's second screen (e.g., the iPad or the like) that describes a potentially interesting fact about the TV set in which the comedy show was filmed.

Annotations such as the one shown in FIG. 1 may be prepared in advance and independently of the given media (e.g., the video) and aimed at enhancing the user's viewing experience. The annotations may be added by expert curators, by crowd sourcing or in a semi-automated way by mining the web. The annotations that are selected for a specific user at a specific time can be displayed on a synchronized second screen app (e.g., the iPad or the like) or directly on a smart TV.

Approaches to the design of a system able to support, in a generalizable way, placing relevant personalized annotations during the playing of the video also must consider the placement of the annotation. The placement of the annotation needs to be sensitive to the user's interests at that point in time while “living in” the media. Approaches to the problem of building such a system that will present informative annotations to a user in this fashion typically end up with a system based on modeling. The system attempts to i) model the user, ii) model the information both in the media (e.g., video) and in the available annotations, and iii) try for an optimized three way match.

The user model may be constructed using available information about past preferences and behavior and about location and other available context parameters. The content of the media and the annotation may be analyzed and characterized as well by using one of the many known methods (e.g., extensive work has been done in generating media attributes in the various “genome” projects, such as the music genome and the movie genome projects).

FIG. 2 shows a high level architecture of an existing system for placing media augmentation.

As shown in FIG. 2, system 200 includes a user model module 202, a media characteristics module 204 with a generation technique module 206, tagged annotations module 208 with a generation technique module 210, a matcher 212, an annotation display 214, and feedback data 216. The matcher 212 makes the user model module 202, the media characteristics module 204, and the tagged annotations module 206 match and optimize for presentation on the annotation display 214. The annotation display 214 then provides the feedback data 216 to the user model module 202 to update the user model module 202.

The user model module 202 employs a model that is described using several sets of attributes of the media in the media model module 204 and all are expressed using a set of attribute-value pairs. The attributes of the media include user's interests and user context (e.g. location, time of day, etc.) and other possible parameters, such as mood. These attributes are acquired by the system 200 in a variety of ways including: statistical modeling of the user, machine learning, social recommendations, collaborative filtering, user-generated attributes and sensor data.

The media characteristics module 204 includes media characteristics that are described using a set of attributes (i.e., metadata). These attributes may cover several aspects of the media and may be derived from efforts such as “the movie genome project.” The media characteristics may also include a map of the media such as table of content or scene descriptions. These media characteristics may be generated in a variety of methods that include using experts (e.g., curators), by crowd sourcing, or automatically using sentiment analysis and tagging techniques.

The tagged annotations module 208 may include tagged annotations created in a variety of ways, including crowd sourcing, semantic tagging, sentiment analysis, friends tagging, source selected by user. Upon matching the attributes of the media to user's interest and to available annotations, a list of possible annotation candidates is generated by the system 200. The list of possible annotations is then optimized to fit the user's state and device.

One of the major drawbacks of the type of a system (such as system 200) is the system's inability to quickly adapt to the user's sometimes transient or opportunistic interests (e.g., the user just came back from a trip to the west coast of the US where he visited NBC studios, so the user suddenly changes interests toward NBC programming) and the changes in the user's attention level as a result of current multi-tasking or recent taxing activities.

Augmenting media with helpful and interesting information has been the focus of various research projects in application areas. Research ranges from collaborative work, where commentaries are added to documents by co-workers, to context and location based reminding applications, and further to reality augmentation, where images of reality are augmented with informative comments to help enhance the mobile user's experience. Tailoring the commentaries to fit the user's context and level of interest is challenging. Most existing approaches to the modeling of user's interests and preferences cannot keep up with the minute-by-minute fluctuations in user focus and interests and are not sensitive enough to support or detect “serendipitous” items of interest.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention plays a media presentation to a user. User data and media data are captured while the media presentation is played. Tagged annotations of the media are provided to the user. A state of the user and a state of the media based on the user data, the media data and the tagged annotations by inferring and reasoning engines are simultaneously computed, wherein the state of the user is computed based on a fluid user model providing a fluid user profile in which user's interests are shifted over time as the user receives the media presentation. Preliminary annotations based on the computed state of the user, the computed state of the media, the tagged annotations, and interaction by the inferring and reasoning engines are inferred. Relatively optimized plausible annotations are generated from the preliminary annotations for a given time interval by an optimization engine; and the tagged annotations of the media are updated with the optimized plausible annotations for the user. The computing, the inferring, the generating, and the updating are repeated as the user receives the media presentation.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an example scenario for media augmentation using a second screen in the prior art;

FIG. 2 shows a block diagram of a system for media augmentation using existing approaches in the prior art;

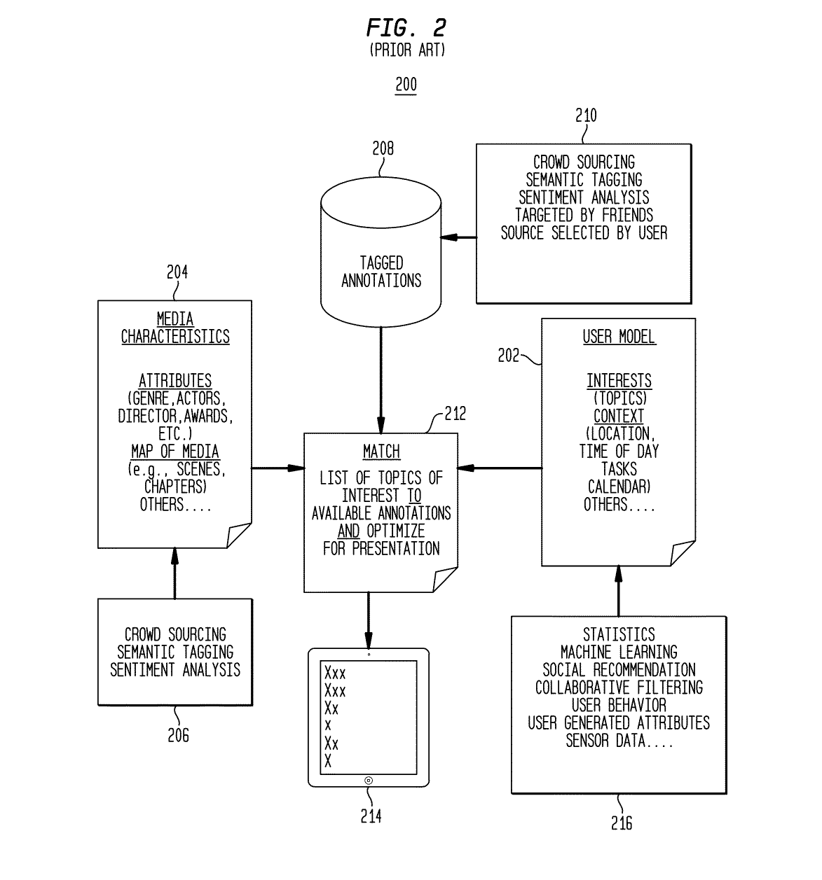

FIG. 3 shows a block diagram of a system for personalized media augmentation using fluid user models in accordance with exemplary embodiments;

FIG. 4 shows a block diagram of a high-level architecture of the system for the personalized media augmentation using the fluid user models shown in FIG. CC3 in accordance with exemplary embodiments;

FIG. 5 shows an “immersive” aspect of a user model for personalized media augmentation using fluid user models in accordance with exemplary embodiments;

FIG. 6 shows a relational diagram of a system for referring a user preference in real-time from a user model and various input parameters in accordance with exemplary embodiments;

FIG. 7 shows a relational diagram of a system for real time inference based on explicit user interests shown in FIG. 6 in accordance with exemplary embodiments;

FIG. 8 shows a flowchart of the system for processing of the real time inference based explicit user interests shown in FIG. 7 in accordance with exemplary embodiments:

FIG. 9 shows a flowchart of four stages of the fluid user models for personalized media augmentations in accordance with exemplary embodiments of the present invention;

FIG. 10 shows a high level block diagram of a system for calculating a state of the user in accordance with exemplary embodiments;

FIG. 11 shows a high level block diagram of a system for calculating a state of a medium in accordance with exemplary embodiments;

FIG. 12 shows a high level block diagram of a system for selecting annotations to match the viewer's moment-by-moment interests in accordance with exemplary embodiments;

FIG. 13 shows a high level block diagram of a system for refining the selected annotations in accordance with exemplary embodiments; and

FIG. 14 shows a block diagram of a computer system for generating the optimized personalized annotations using fluid user models in accordance with exemplary embodiments.

### DETAILED DESCRIPTION

Hereinafter, exemplary embodiments are described with reference to the drawing figures.

Described embodiments relate to systems and methods employing fluid user models for personalized mobile applications, referred to herein also as recommender systems. The described embodiments are designed to augment media with additional information highly personalized to a user based on a variety of factors with different time sensitivity and include, but are not limited to, a user's general preferences, history, immediate context and attention, and emotional states when the user experiences and/or interacts with the media. Embodiments solve various problems of information overload stemming from both i) the complexity in characterizing the information and ii) its potential relevancy and in understanding and coding the user's needs.

One of the most common examples of augmenting movies with information is the addition of subtitles that provide a synchronized translation of the movie's dialogue to other languages or that convert the soundtrack to text for the hearing impaired. Also, directors' and actors' commentaries, and other special features on the DVD releases of movies, provide additional insights into the making of the movie and its background and is a highly popular offering. Also, a variety of new applications for social TVs are being offered where the viewers can send to each other real time commentaries via a second screen (e.g., a tablet or a smart phone) or to their friends via a social network, Twitter or other applications.

The described embodiments of the present invention are to take the above offering a step further and add annotation to the media that are personalized to the specific user's needs, interests and context at the time of viewing the movie. Embodiments track relevant parameters about the user as the user watches, for example, the movie and tailors the commentaries to each specific segment, taking into account both the state of the user and the state of the movie.

In order to aide in the understanding of the present invention, the following describes operational examples, corresponding applications, and filtering systems. In addition, user models and associated types of information are described as might be employed by a recommender systems operating in accordance with exemplary embodiments of the present invention.

Two examples of operation of the present invention are as follows. In example 1, the user is watching the movie “Anywhere but Here”. Realizing that the user is interested in technology revolutionaries and given the fact that Mona Simpson, Steve Jobs' biological sister, wrote the autobiographical book that the movie is based on, the system can highlight facts about Jobs biological mother and father. Furthermore, the system can make the decision on whether or not to display this specific commentary based on whether the user is in the right frame of mind (e.g., not too tired) and can pay sufficient attention (e.g., the user is not reading his email at the moment or speaking on the phone).

In example 2, the user is watching the movie “Breakfast at Tiffany's.” Realizing that the user is interested in the life of writers, the system can highlight autobiographical facts in the movie as well as facts like “Truman Capote wrote the book with Marilyn Monroe in mind for the main role” as other well as additional background commentary. Since such inside information usually energizes the user, i inside information t can be provided in particular positions and/or time instants when the user is tired or in a melancholy mood.

The problem of automatic media augmentation can be viewed as related to the problem of content recommendation with the added requirement that the information being added to the media (e.g., comments) is relevant both to the media it is being added to and to the user that will eventually read and benefit from it. This additional constraint is not fully met in today's recommender systems. Recommender systems have been designed to automatically select information that is relevant to the user by matching a set of user attributes (e.g., a user model) to a set of attributes that describe the available information (e.g., metadata or a bag of words) and picking the most relevant match based on predefined criteria.

Examples of applications of the recommender systems include: offering movie recommendations to users of a streaming movie service (e.g. Netflix) based on a prediction of their taste in movies, and offering users of an on-line retailer suggestions about which item to buy based on their history of purchase (e.g., Amazon's book recommendations).

Traditionally, the recommendation systems use a number of different technologies that can be classified into two broad groups of filtering systems. Content-based systems look at the properties of the items. For example if a Netflix user has watched many romantic comedies then the system would recommend a movie classified in the database as having the “romantic comedy” genre. Collaborative filtering systems recommend items based on similarity measures between users and/or items. The items recommended to the user are those referred by similar users. The paradigm used by these two groups of the recommender systems categorize the user interest and the items by explicit or implicit attributes and find the optimum match, either by directly comparing the two lists (i.e., Content based systems described above) or by deriving the match through choices of other users with similar histories.

The user model represents a collection of personal data associated with a specific user. Which data is included in the model depends on the purpose of the application. The data can include personal information, such as the user's name and age, the user's interests, the user's skills and knowledge, the user's goals and plans, and the user's preferences and dislikes. The data can also include data about a user's behavior and a user's interactions with the system.

A distinction between stereotypical and personalized user models is as follows. The stereotypical user models are based on demographic statistics. Using such a model allows an application to make assumptions about a user even though there might be no data about the specific user in the specific application area. The stereotypical models are usually static or change very slowly. The personalized models, are highly adaptive based on the user's behavior and stated preferences, but require gathering information from the user before they can be used.

In most applications the information that is needed to populate the user model is very sparse. As a result certain assumptions have been used to infer as much information as possible from existing data. In most cases, these assumptions take the form of the following heuristics. For a first heuristic, if two users have shared some interest in the past, for example, they liked the same book or movie in the past, then they are likely to a certain degree to share interests in the future, for example, buy the similar items in the future. So if one of them buys a new book or rents a new movie, one can assume with some probability that the other one will be interested in buying it as well. For a second heuristic, if a user likes an object, the user is likely to like a reasonably similar object in the future.

These two heuristics have proven useful in several application scenarios, such as recommendations for books and movies; and improvements constantly increase their effectiveness. As the various studies have indicated, these improvements might be very specific to the specific application domains and, in most cases, do not transfer easily to other application (even quite similar) domains.

Two further user model assumptions that are related to temporal and contextual effects are as follows. If the user did not like an object at time T he is likely not to like it at time T+Δ, where Δ in most cases is very large. If the user did not like an object in context C₁ he is likely not to like it in context C₂. This implicit assumption is a direct result of the fact that in most cases context is not considered as a parameter. These two implicit assumptions turn out to be very problematic when it comes to providing relevant information to a user in a media immersive environment where the context, the required attentions, the mood and the subject matter may shift rapidly and dramatically over arbitrary time intervals.

The user identifies him/herself to the system before it can personalize the information that it provides. This identification might be by either an explicit login or, automatically, if the user uses the user's own personal mobile device such as a smart phone or a tablet. In the case of groups viewing, a group profile may be constructed by the system.

The described embodiments disclose an approach for the construction and management of user's models during the immersive interaction of the user with (or in) the media. The approach results in an inherently flexible and dynamic user model, termed herein as the “fluid user model”, that treats user's location, context, attention level and activities as central to the determination of information relevancy.

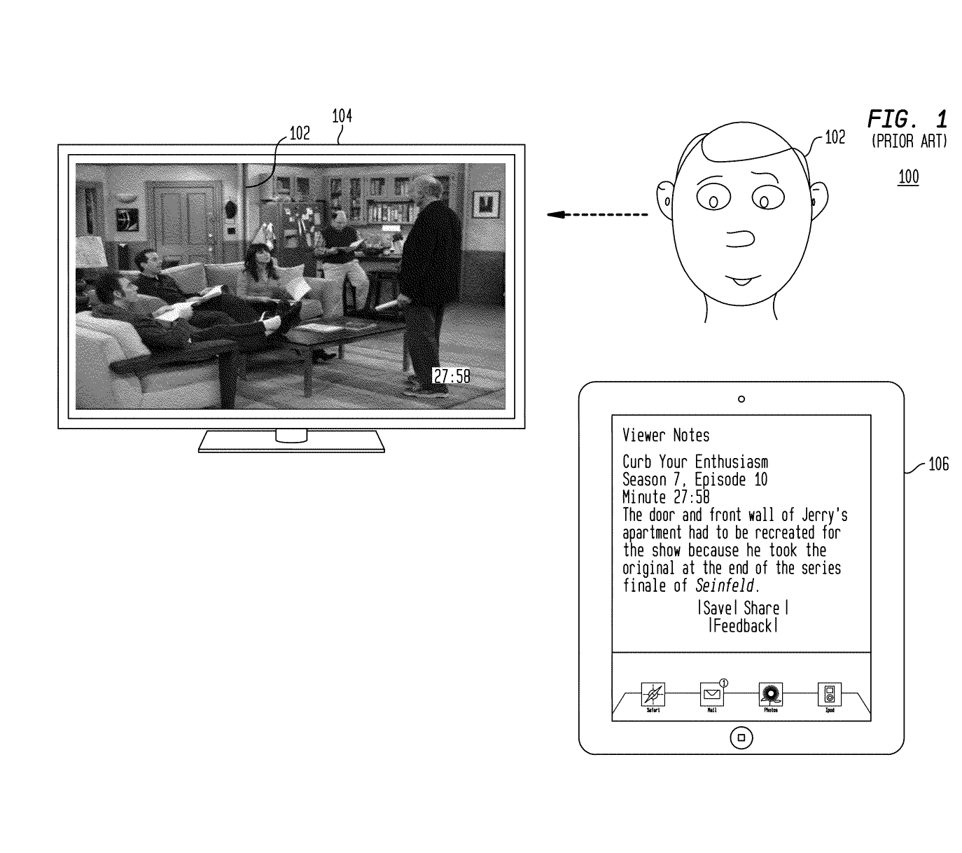

In order to describe the fluid user model and discuss its usefulness for the problem of media augmentation, the example of the media augmentation for the example shown in FIG. 1 is now described for the addition of the annotation to the running media employing the above-described fluid user model.

Table 1 below shows three examples of the annotations and sample of other information items that may enable the optimal placement of the annotation in the video segment. Table 1 also shows some metadata that could be useful in characterizing the relevance of the annotation as it relates to specific user interests.

TABLE 1

| Annotation examples | Metadata | | Ideal video |
|---|---|---|---|
| (Including source) | (Subset) | Attention level | interval |
| In the reconstruction of Jerry's apartment on the | Production notes | Medium | 27-31 min |
| set, the door and front wall had to be recreated | Jerry Seinfeld | (e.g., some multi- | (When that part of |
| because Jerry took it at the end of the series finale | Seinfeld series finale | tasking) | Jerry's apartment |
| of Seinfeld in 1998. | Celebrities behavior | | is visible) |
| | Silcom sets | | |
| Application developers external from Apple, Inc, | iPhone | High | 33-42 min |
| only eam about $700/year on average for the apps | Entrepreneurship | (e.g., no multi-tasking, | (When George's |
| they create. | Hype vs. Reality | high energy) | iPhone app startup |
| | | | is discussed) |
| Jason Alexander not only took the last name | Jason Alexander | Low | Any time that lits |
| “Alexander” because of his father's first name, but | Actors hard life | (e.g., heavy multi- | based on the flow |
| it also helped him in auditions since the call backs | Auditions | tasking or low energy | of the plot and the |
| were done in alphabetical order and thus he knew | | level) | attention level of |
| immediately if he was still in the running, or not, | | | the viewer |
| for parts. | | | |

Table 1 includes the following information:
1. Annotation's text and source as shown in the first column.
2. Metadata, as shown in the second column, that could be useful in characterizing and determining the relevance of the annotation as it relates to specific user interests at specific points in time. This information can be derived ahead of time manually or semi automatically based on plot summaries, close captions as well as a variety of audio fingerprinting and information gathered from social media, information website and the like.
3. The optimal attention level of the user, as shown in the third column, which allows the user to fully benefit from the annotation. As an example, the levels as “low” “medium” and “high” are described, but other schemes (e.g., various numerical scales) can be used as well.
4. The ideal video interval, as shown in the fourth column, in which the annotation is effective.

A direct result of inferring a user's preferences in real time based on a set of variables including user's attention level, context and recent history is the fact that the user model becomes highly fluid. The fluid user model includes an extensive list of preferences based on general disposition, taste and past behavior. In addition, the fluid user model also includes a list of inference rules about interestingness that are used to compute a current interest level based on a variety of time dependent parameters including content, mood, emotion, level of attention and recent history.

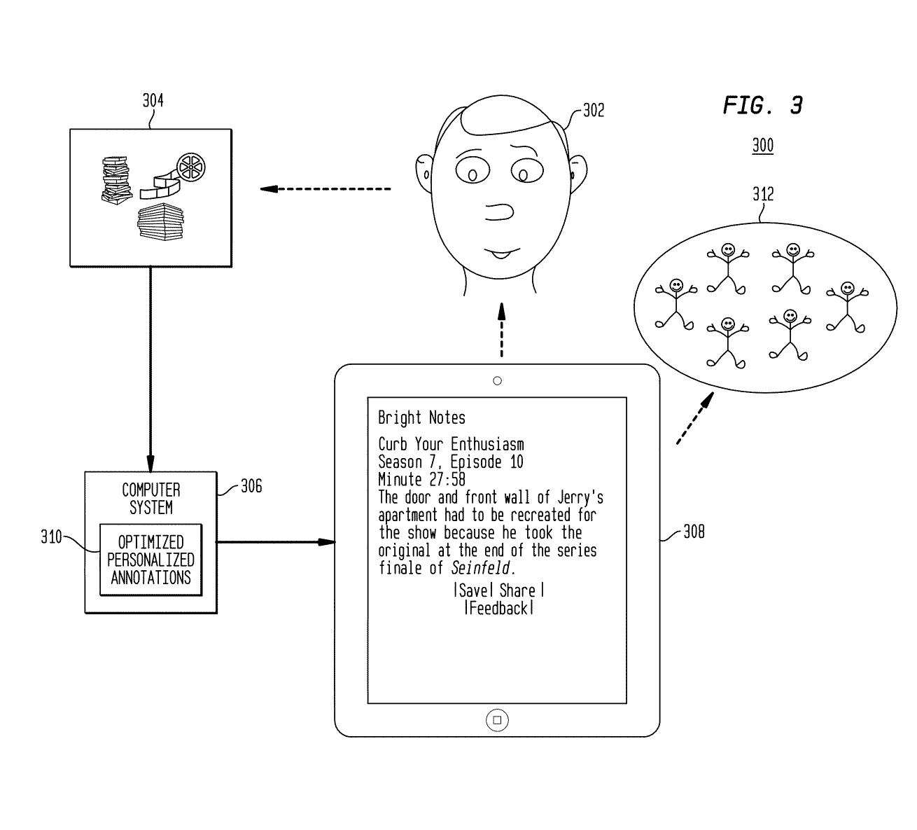

FIG. 3 shows a block diagram of a system for personalized media augmentation using fluid user models in accordance with exemplary embodiments of the present invention. System 300 includes media 304, a computer system 306, and an electronic display 308. The system 300 provides a user 302 of the media 304 with relevant optimized personalized annotations 310 displayed on the display 308, while the user 302 is watching a video on the media 304. The relevant optimized personalized annotations 310 are generated by the computer system 306 using fluid user models, as described above. The relevant optimized personalized annotations 310 generated with the fluid user models enhance the value and timeliness of the presentation of media 304 and enhance overall experience of the user 302. The optimized personalized annotations 310 are computed based on characteristics and information of the media 304 and the personalization of the user 302 that includes the user 302's general information including user's interests, likes, dislikes, current context (e.g., location, date and time), mood, energy level, current activities (e.g., multi-tasking), recent history (e.g., activities of the past day or two), longer term history (e.g., activities such as travel and family events), future plans (e.g., as reflected in user's calendar, to-do list or longer term events and travel plans).

The system 300 selects the appropriate optimized personalized annotations 310 from a large database either in real time, near real time or in advance as appropriate to send to the display 308 as “Notes” that offers messages to the user 302 with digital texts, audio, video, or the like. The optimized personalized annotations 310 may be displayed as text, audio or video and can be rendered by the same device used to consume the original media (e.g., the medium 304) or by a second device (e.g., the electronic display 308). The optimized personalized annotations 310 may be stored in a file for the user 302's later use. The optimized personalized annotations 310 displayed on the electrical display 308 may also be shared with other users 312 who may have the similar interests as the user 302. The computer system 306 may include a server that receives the personalization data collected from a plurality of users and aggregate the personalization information on the plurality of consumers who observe the video on the medium 304.

As used herein, the user 302 may be a consumer, a video watcher, a viewer or an individual who uses the media. Thus, the terms “user”, “consumer”, “individual”, “video watcher” and “viewer” may be used interchangeably herein to refer to a person who uses media.

The user 302 may express interests and moods before watching the media 304. Once the user 302 receives the Notes of the optimized personalized annotations 310, the user 302 may elect to share interesting personalized annotations with his/her social network seamlessly. The sharing may take the form of a text note or “tweet” saying “did you know that . . . ”, or the user generated information can be stored as part of the media and be shown to the friend later only when the friend watches the same media.

The media 304 may be consumer electronic devices such as a smart TV, a laptop, a tablet, a smart phone or other electronic medium devices. The medium 304 may show a video, a webpage, a website, a web-enabled application, or other similar presentations.

The display 308 may also be implemented with common consumer electronic devices such as a smart TV, a laptop, a tablet, a smart phone or other electronic media presentation devices. The electronic display 308 displays Notes as text, audio, video, or the like. The display 308 may include a computer display, a laptop screen, a mobile device display, a cell phone display, or some other electronic displays. The display 308 may also include a keyboard, mouse, joystick, touchpad, wand, motion sensor, and other input means.

The optimized personalized annotations 310 may be performed based on the information both about various aspects of the media and its production history and about its relevancy to the interests and preferences of the user 302 which are gathered through the user 302 viewing a prior or current media presentation (e.g., a website, a digital video including a movie and a recorded TV program).

The optimized personalized annotations 310 generated for the user 302 may be displayed in different ways, including on the main viewing screen of the media 304, on a second screen or stored in a file to be viewed by the user at a later time. The optimized personalized annotations 310 may include, in addition to text, images, graphics and video as well as audio.

A user's feedback, either explicit through an associated interface or implicit by viewing behavior maybe captured and taken into account in the future. The use of the user's feedback includes, but is not limited to, determining if this or similar annotations show again in the particular media or in others for this user only or for similar users as well.

It is known in the art that people cannot reliably predict their own behavior in advance. Consequently, if a system is to predict what a user would like to hear about at a particular time and place, such prediction might generally be inferred in real time using diverse information sources. In the described embodiments of the present invention, the user's interest and the relevancy of the information to the user are both computed (e.g., inferred) simultaneously because, in many cases, the meaning, relevance and intrinsic interest value of a piece of media is a function of the interpretation of the particular media by the user at the time of viewing, not in advance, when the user declares his preferences or rates a prior selection of a movie or a book.

A direct result of inferring the user's preferences in real time based on a set of variables including attention level, context and recent history is the fact that the user model becomes highly fluid. The fluid user model includes an extensive list of preferences based, as is the case above, on general disposition, taste and past behavior. In addition, the model also includes a list of inference rules about interestingness that are used to compute the current interest level based on a variety of time dependent parameters including content, mood, emotion, level of attention and recent history.

The fluid user model is an immersive model in which non-static descriptions of a user profile and preferences that involve real-time inferencing based on a dynamic user model which include multiple static and dynamic variables, resulting in a fluid user profile that shifts user's focus over time as the user goes through the media.

Media users, such as video watchers, in general enjoy the “special features” that come with the media releases, such as DVD releases of movies and TV shows. This extra material provides another perspective on the videos and the people that were involved in producing it. For example, a few years ago, when the studio decided to no longer provide the material as part of DVD rentals and only include it for people who purchase them there was a big outcry of the video watching community, which indicates the value of this material.

Another media augmentation example is annotating and adding commentary to books. When it comes to commentaries on the books, the Bible commentaries as well as commentaries on Shakespeare work are common examples. Other examples include collaborative work environments where people can leave comments. Several classes of applications, in addition to the video augmentation example shown above, where augmenting an existing media can play a part include: i) Augmenting Games; ii) Augmenting Educational Material; and iii) Augmenting “Reality”.

For Augmenting Games, the user and the game are molded by the system and the system can provide additional information to the user (e.g., in the form of advice). This application scenario can be used for training purposes as well. For Augmenting Educational Material, existing material is augmented with annotation and commentary base on the pupil's interest and level of knowledge. For Augmenting “Reality”, augmented reality is an immerging application domain and includes in addition to information, c-commerce and entertainment applications also several applications in the military domain.

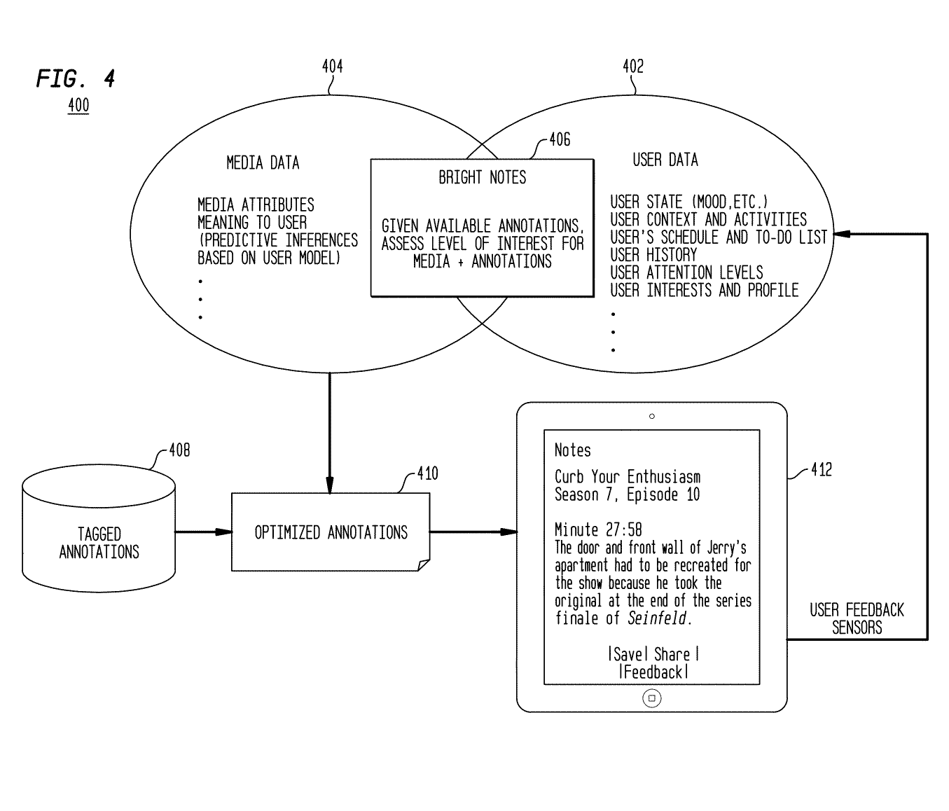

FIG. 4 shows a block diagram of a high-level architecture of the system for personalized media augmentation using fluid user models shown in FIG. 3 in accordance with exemplary embodiments of the present invention. As shown, a system 400 includes user data 402, media data 404, Bright Notes 406, tagged annotation database 408, optimized annotations 410, and annotation display 412.

The user data 402 includes static user data and non-static user data. The static user data includes user's general information such as user's interests, context (e.g., location, time of day, tasks, calendar), and the like. The non-static user data includes user's transient information that records the user's data in real time. The non-static user's data includes user's current context (e.g., location, date and time), current mood, current energy level, current activities (e.g., multi-tasking), recent history (e.g., activities of the past day or two), longer term history (e.g., activities such as travel and family events), future plans (e.g., as reflected in his calendar, to-do list or longer term events and travel plans), transient or opportunistic interests, user's attention level as a result of current activities or other attention grabbing activities, and the like.

As described in FIG. 3, the user 302 may express interests and moods before watching the media 304. Thus, the user data 402 may include the information about the user's expression of interests and moods before watching the media 304.

The media data 404 includes static media data and non-static media data. The static media data includes media metadata that capture known facts of the media such as a genre, elements of a media presentation (e.g., a plot, or a segment of a video), other known facts, and a map of the media such as a table of contents or scene descriptions. The non-static media data refer to transient data of the media that includes sensor data captured from the media in real time including current sound track for the media, visual snippets of the media, or the like.

The media data 404 is described not only with static metadata that capture the genre, elements of the plot and other known facts about rather, aspects of its description are computed dynamically for the user at the time the user is watching it. Consequently, a piece of media may include different descriptions for different users. For example, if the user is watching a war movie that was filmed near his hometown, for example, the filming location is relevant for him and will be mentioned as part of the movie description. This same fact will not be included in the movie description for other users that have no potential interest in this location. A reasoning/inference engines can perform these dynamic computations.

The module Bright Notes 406 implements the fluid user models for various user applications and the inference and reasoning engines associated with it. The module Bright Notes 406 receives media and user data and processes the various data in accordance with the fluid user data model described above. The module Bright Notes 406 provides available annotations, and accesses level of interest for the media and annotations. The available annotations provided by the module Bright Notes 406 are generated by the inference and reasoning engines that are processors in the computer system shown in FIG. 3.

The inferring and reasoning engines use inference rules to infer plausible interests and annotations based on the diverse information available about the media (e.g., video), the user and their interaction.

The inferring and reasoning engines compute and infer the annotations based on the user's data, the media data and tagged annotations (not shown). The inferring and reasoning engines compute a user's state and a media state simultaneously first, and then use the results of the user's state, the media state and the tagged annotations to generate a list of preliminary annotations. The engines then optimize the plausible annotations selected from the list of the preliminary annotations. The state of the user includes user's interests, preferences, context, mood, attention level and user's similar transient parameters. The state of the media includes attributes of the media that help pinpoint parts of the time dependent media involved. These attributes include scenes, music score, clock time, screenplay, music score, shooting locations, casting, productions, and the like of the media.

The state of the user is computed by the inference and reasoning engines using the fluid user model that represents a collection of user interests. Some of these interests are relatively static while others are highly time and context sensitive and should be derived (e.g., inferred) in real time using knowledge about the user's immediate environment and recent history. At any given time during the watching of the video, the user's primary interest can shift and, as a result, the optimal annotations may be presented shift as well.

Here the inference rules include rules that match the user current state with available annotations that are relevant to the place he is at in the movie. For example, a rule can state “if the user is in a good mood and is fully engages with the movie and there is an annotation that fits the section of the movie he is watching (namely it fits the user mood and attention level) then display it to the user”.

The module Bright Notes 406 allows system 400 to quickly adapt to the user's occasional transient or opportunistic interests. For example, the user just came back from a trip to the west coast of the US where the user visited the studios of the national broadcasting company (NBC), or the movie the user is watching was shot near the user's home town, or one of the minor actors in the movie the user is watching went to the same high school as the user.

Once the user receives the output of the module Bright Notes 406, the user may elect to share interesting personalized annotations with his/her social network seamlessly. The sharing may take the form of a note or tweet saying “did you know that . . . ” or can be stored as part of the media and be shown to the friend only when the friend watches the same media

Furthermore, the system 400 is able to capture the changes in the user's attention level as a result of current multi-tasking or other attention grabbing activities.

The tagged annotation database 408 includes annotation information derived ahead of time manually or semi-automatically based on plot summaries, close captions as well as a variety of audio fingerprinting of the media (e.g., a video or movie).

Additional information types can be captured and the associated annotation essence may also be added. All of this information is stored in the tagged annotation database 408 that can reside in a variety of locations, including the cloud and the user second screen device that will be accessible to the system.

The optimized annotations 410 are the annotations obtained by filtering the annotations generated by the inference and reasoning engines by an optimization engine in the computer system shown in FIG. 3. The optimized annotations 410 eventually display on the annotation display 412 to demonstrate to the user.

The optimized annotations 410 generated for the user may be displayed in different fashions including on the main viewing screen of the media 304, on a second screen or stored in a file to be viewed by the user at a later time. The optimized annotations 410 may include in addition to text, also images, graphics and video as well as audio.

The annotation display 412 may be an electronic display device as shown in FIG. 3. Similar to the electronic display 308, the annotation display 412 may be implemented with common consumer electronic devices such as a smart TV, a laptop, a tablet, a smart phone or other electronic devices.

Once the optimized annotations 410 are displayed on the annotation display 412, the annotation display 412 provides a user's feedback to the user data 402 through a feedback sensor (not shown). The user's feedback either explicit through an interface or implicit by viewing behavior will be captured and taken into account in the future. The user's feedback includes, but not limited to, determining if to show this or similar annotations again in the particular media or in others for the user or for similar users who have similar interests to the user.

In the system 400, user's attention is being computed and monitored based on the inference rules and other inputs listed in the user data 402, such as the level of multi-tasking of the user, the level of activities of the user during the past day, and the like. Furthermore, as the user is watching a video on the media as shown in FIG. C, the level of interest that the user may have in the different media content attributes at different points in time is being computed and new media attributes included in the media data 404 of potential interest are being inferred based on the user's recent history and activities included in the user data 402.

For example, if the user is taking action towards starting a new mobile application business, the second annotation in Table 1 below may be of interest. Although the annotation is not really part of the video but derived from it—in the video it is mentioned that one of the characters made millions in a New York startup that made an iPhone app. So in this case, the annotation is not derived directly from the video metadata but is rather inferred based on knowledge about the user's current interests. For other users that are not into starting businesses such as attribute of the video would not be considered. This serendipitous mentioning of the annotation is then an integral part of the fluid user model.

After the system 400 highlights the optimized annotations 410 as annotation candidates for display on the annotation display 412 to the user, the user may select the most appropriate part of the video, if the user is up to seeing this fact now.

The third and fourth columns of Table 1 show some of the additional information—user's attention level and idle video interval—that are needed by the system in order to make the above determination. This information can be derived ahead of time manually or semi automatically based on plot summaries, close captions as well as a variety of audio fingerprinting. The information can then be stored in a tagged annotation database 408.

When an annotation is picked as potentially of interest to the user, e.g., the user is interested in start-ups that develop mobile applications and the content of the video is relevant for the second annotation above shown in Table 1, further filtering is performed to make sure that the user has sufficiently high attention level to be able to absorb that annotation and find it interesting. In the case of the second annotation, the user needs to be at high attention level to make sense of it. If this condition is not met, other potentially relevant annotations will be examined to find one that fits the user's current attention level.

Both the video and the annotation can affect (positively or negatively) the user's attention resources and this is also taken into account when annotations are selected. In cases where the user is watching a video the user watched before, (e.g. re-runs) other rules can be applied that account for higher attention potential as the level of attention needed to process the re-run is less and therefore more attention is available to process the annotation.

In addition to media based annotations as described above, an ambiance (e.g., lighting) and sound level of the media may be applied based on the state of the user and the media.

The annotation mechanisms described above may apply to other domains such as gaming, education and augmented reality.

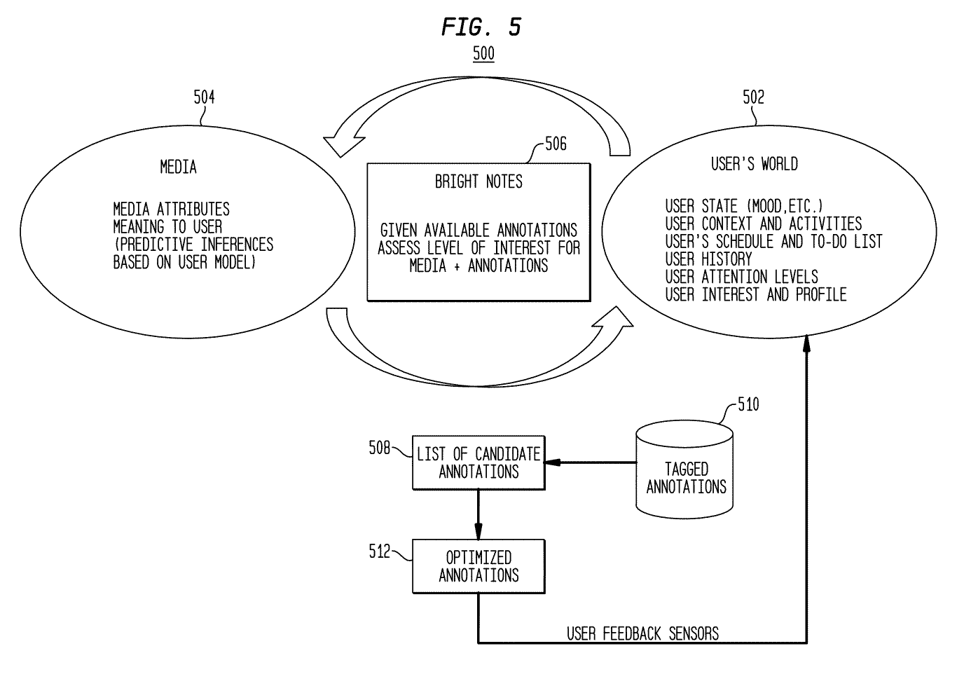

FIG. 5 shows an “immersive” aspect of a user model for personalized media augmentation using fluid user models in accordance with the described embodiments of the present invention. As shown, system 500 includes user model 502, media 504, Bright Notes 506, list of candidate annotations 508, tagged annotations 510, and optimized annotations 512.

Media (in particular, movies) can create an immersive experience for their reader/viewer/user. In the case of movies (in accordance with the exemplary embodiment described herein), when a user views a movie, the user's mood, focus and attention level may vary throughout the media/movie.

In FIG. 5, the “meaning” of the movie to a user at any given time is relative to the state of the user at that time. Furthermore, in the case of the media being a movie, the state of the user is also influenced by, among other things, what the user has seen so far in the movie. In this immersive user model an extensive use of inferencing to derive the current state of the movie and the current state of the user from the user and media models is made.

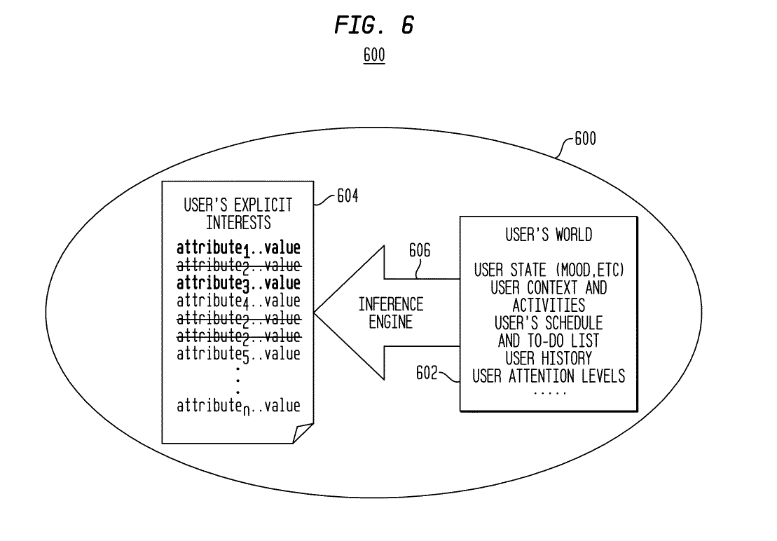

In the system 500, the user model accounts for temporal dependencies and the user's “attention” is a key and perishable resource for using inferencing to derive the current state of the movie and the current state of the user. Furthermore, the media's relevancy is viewed from the user's perspective at any particular time. Extensive cognitive science research shows that a user's mood, context, recency, history and energy level influence the user's preference. FIG. 6 shows a relational diagram of the system 500 between user world data and the user's interests, expressed as attributes, referring to a user's preferences in real-time. As shown, relational diagram 600 includes user's data 602, a list of user's explicit interests 604, and inference engine 606. The user's data 602 includes user's static data and non-static data including user's state (e.g., mood, context, activities, schedule, history and attention). The list of user's explicit interests 604 includes user's multiple interests including attribute₁, attribute₂, . . . attributeₙ, where n is an integer. The inference engine 606 infers the list of user's explicit interests 604 based on the user's data 602.

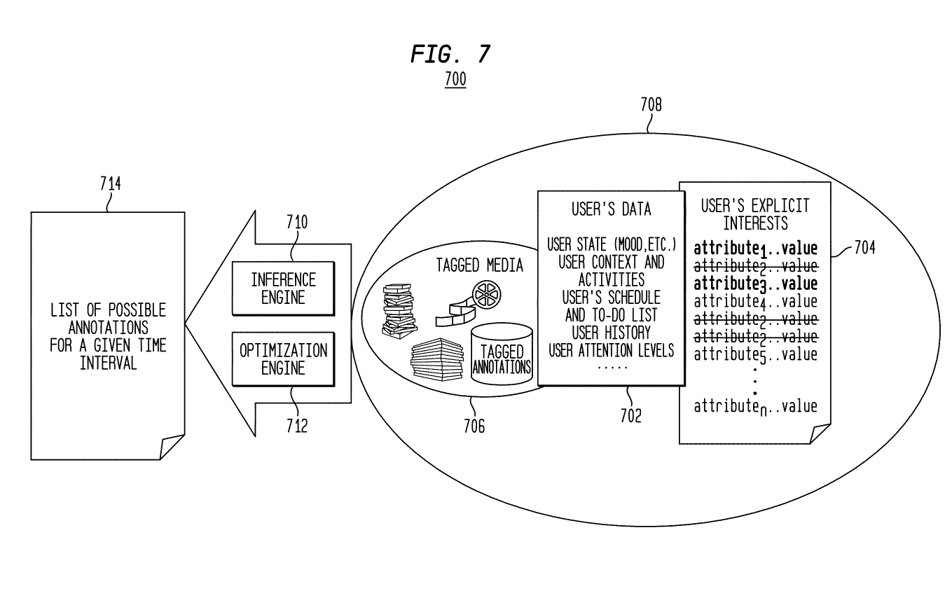

FIG. 7 shows a relational diagram of a system for real time inference based on explicit user interests shown in FIG. 6. That is, FIG. 7 shows that how the system uses further inferencing to determine both the user interests and the media attributes that are meaningful to the user at his current state to produce a list of possible annotations for that particular moment in time.

As shown, system 700 includes data collectively shown as a personalized user model 708, inference engine 710, and optimization engine 712, which generates a list of possible annotations 714. The personalized model 708 includes user's data 702 having static user information and non-static user information, user's explicit interests 704, and tagged media 706 including media data and tagged annotations.

The inference engine 710 examines at various aspects of the tagged media 706 and derives possible annotations 714 (e.g., interests) base on the user's data 702 (e.g., correlates a recent trip the user took with a movie shooting site). The user's explicit interests 704 are generated based on the user's data 702, whereas, the tagged media 706 are generated based on the media data and tagged annotations. The optimization engine 712 assesses possible impact of an annotation on user's data 702 (e.g., distracting, energizing, and confusing.). Both user's explicit interests 704 and tagged media 706 are computed simultaneously in real- or near-real time within the personalized model 708 to produce a list of possible annotations for a given time interval by the inference engine 710 and the optimization engine 712. All of this can be done in near-real time or in advance although real-time tracking of user's mood and multi-tasking may influence the value of specific annotations. There are several technologies that are available today to gather information about the user state (e.g., the user's mood and level of multitasking). Some proposed systems monitor the user's mood while watching a video by analyzing facial expressions and comparing them to a library of typical expressions and the mood they represent. See, for example, US patent publication 2012/0222058 entitled “Video Recommendation based on Affect”, filed Feb. 27, 2012, the teachings of which are incorporated herein in their entireties by reference. For determining the level of user multi-tasking, a user's activities can be tracked through the user's mobile device, such as described in EP patent EP2518676A1 entitled “Method of Tracking Software Application Internet Downloads”, filed on Nov. 2, 2011, the teachings of which are incorporated herein in their entireties by reference. Furthermore, user activities can be tracked in a variety of ways including using technology based on motion detectors, such as described in US patent publication 2007/0276295 entitled “Motion Detector for a Mobile Device”, filed on May 25, 2006, the teachings of which are incorporated herein in their entireties by reference.

Media attributes, including the various “genome” projects, and insights available from cognitive science research on relationships which govern people's attention, focus and over all priorities and interests but it is often not in an immediate usable form, is applied. This knowledge can be formulated as heuristics of rules that take the form “IF the user is in state X and in context C and with additional constraints being satisfied THAN do the set of actions A (which includes drawing further conclusions), UNLESS the following set of conditions is true”. These rules are referred to herein as “inference rules” and are used drive the inference and optimization engines. The set of inference rules might start out very simple and be refined by the system or by a human operator over time. An example of a general inference rule includes a rule that matches the user current state with available annotations that are relevant to the place he is at in the movie. For example, a rule can state “if the user is in a good mood and is fully engages with the movie and there is an annotation that fits the section of the movie he is watching (namely it fits the user mood and attention level) then display it to the user”.

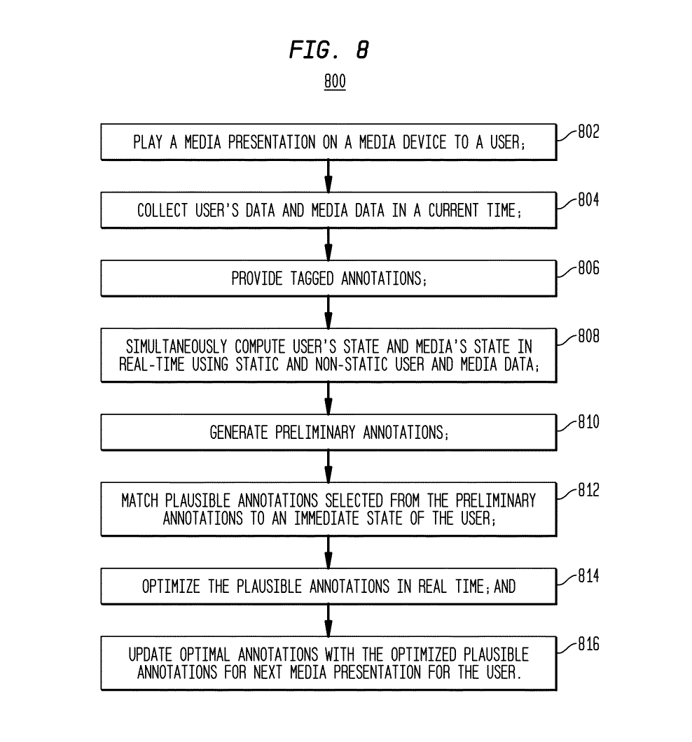

FIG. 8 shows a flowchart of the real-time, inference-based processing of explicit user interests shown in FIG. 7. As shown, at step 802, process 800 starts with a media presentation to a user playing on a device. At steps 804, while the media presentation is played, user's data and media data are collected by a computer system that communicates with the media through Internet. The media's data includes static media data and non-static media data. The user's data includes static user data and non-static user data. The non-static user's data and non-static media data are captured at a current time. At step 806, tagged annotations for the user are provided. The tagged annotations are stored in the computer system. At step 808, a user's state and the relevancy of a media state to the user are both computed (e.g., inferred) simultaneously. That is, modeling of the media and modeling of the user are performed in parallel. As to the modeling of the media, the media is described not only with static meta data that capture the genre, elements of the plot and other known facts about rather, aspects of its description are computed dynamically for the user at the time the user is watching it. Consequently, a piece of media may end up with different descriptions for different users. As to the modeling of the user, an immersive model of the fluid user model is applied, in which non-static descriptions of a user profile and preferences that involve real-time inferencing based on a dynamic user model which include multiple static and dynamic variables. This results in a fluid user profile that shifts focus over time as the user goes through the media. Reasoning/inference engines may perform these dynamic computations. Here, the user's state includes user's interests and the media state includes the media information to the user. At step 810, preliminary annotations are generated with the inputs of the user's state and the media state. At step 812, plausible annotations are selected from the preliminary annotations. The plausible annotations are then matched to an immediate state of the user. At step 814, the plausible annotations are then optimized in real time. At step 816, optimal annotations are updated with the optimized plausible annotations that will be used for next segment or other media presentation for the user.

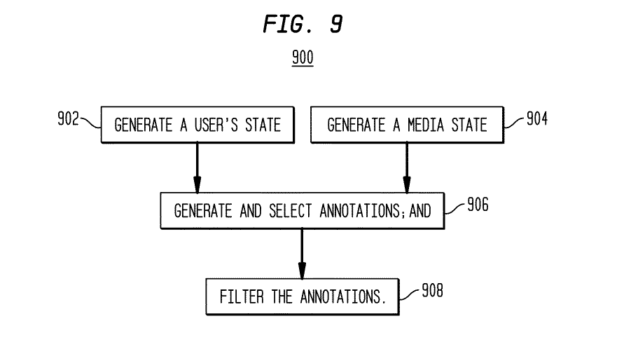

The above described embodiments for the fluid user models for personalized media augmentations (e.g., mobile applications) generally include four stages, as shown in FIG. 9. As shown, a particular embodiment of a system, shown as system 900, includes first stage 902, second stage 904, third stage 906, and fourth stage 908. The first stage 902 produces a state of a user. The second stage 904 produces a state of the media, and is generally performed in parallel with first stage 902. The third stage 906 generates a list of preliminary annotations. The fourth stage 908 generates current annotation candidates. These four stages are described below with various system flows.

A system that controls the fluid user model contains inference engines that use inference rules to infer plausible interests or annotations based on the diverse information available about the media (e.g., video), the user and their interaction.

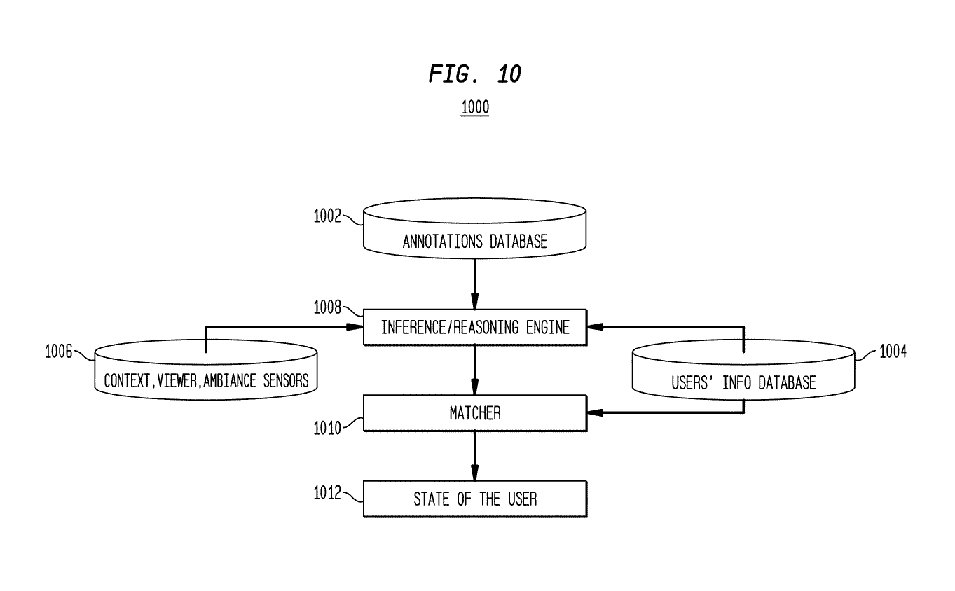

FIG. 10 shows a high-level block diagram of a system for calculating a state of the user. System 1000 includes annotation database 1002, user's information database 1004, user's current context 1006, inference/reasoning engine 1008, matcher 1010, and a state of the user 1012. The inference/reasoning engine 1008 computes a state of the user based on the data from the annotation database 1002, the user's info database 1004, and the user's non-static data 1006. As described above, at any point in time, the state of the user includes user's interests, preferences, context, mood, attention level and user's similar transient parameters. In this case the inference/reasoning engine 1008 examines the items in the annotations database 1002 and at data about the user's current context 1006 and other immediate parameters and the user's interest and preferences as represented in the user's information database 1004 and infers the state of the user 1012 at this particular moment. The matcher 1010 matches the calculated results to the user's info database 1004 before sending the state of the user 1012 out.

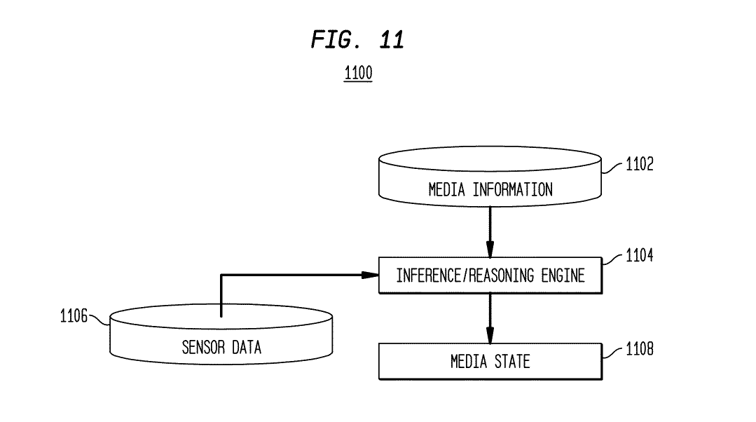

FIG. 11 shows a high-level block diagram of a system for calculating a state of a medium. Several attributes that help pinpoint parts of the time dependent media are considered. These attributes include scenes, music score, clock time, screenplay, music score, shooting locations, casting, productions, and the like. The attributes provide the overall system with a way to keep track of the time line and conceptual location of the viewer at any time and along all the dimensions. This allows for determining the optimal location of annotations.

As shown in FIG. 11, system 1100 includes media data 1102, inference/reasoning engine 1104, sensor data for the media 1106, and a state of a media 1108. The media data 1102 is generally media information that is provided to the inference/reasoning engine 1104 together with sensor data 1106. Media information could include the current sound track for the media, visual snippets of the media, etc. Sensor data 1106 is data collected locally of the media presentation, as the user perceives it, such as current position of audio and video portions. The inference/reasoning engine 1104 then uses this information to determine the current “location” of the media (i.e., the current annotation of the media). Once obtaining the state of the user and the state of the media, the process moves to the step of selecting annotations.

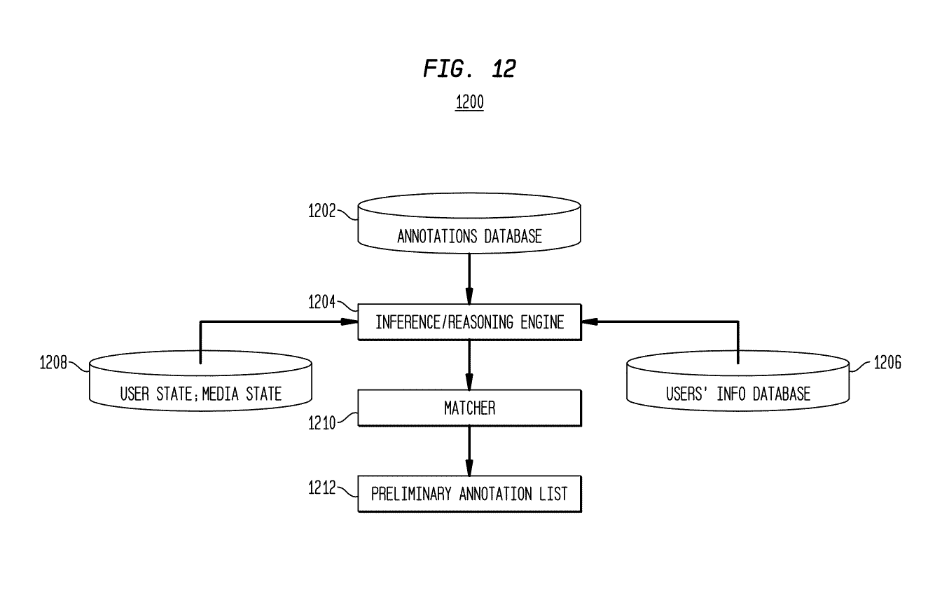

FIG. 12 shows a high-level block diagram of a system for selecting annotations to match the viewer's moment-by-moment interests. As shown, a system 1200 includes annotation database 1202, an inference/reasoning engine 1204, user's information database 1206, an input of user's state and media state 1208, a matcher 1210, and a list of preliminary annotations 1212. The inference/reasoning engine 1204 infers a list of preliminary media annotations based the annotation database 1202, the user's information database 1206, and the input of the user's state and media state 1208. The matcher 1210 matches the list of the preliminary media annotations with the state of the viewer and the media. Here, the structures of the list of the preliminary media annotations are as described in Table 1 above.

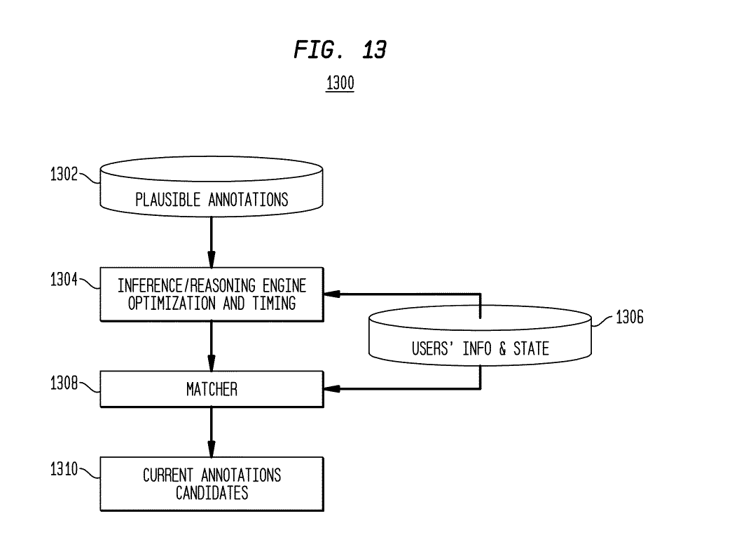

The flow shown in FIG. 12 shows an initial selection of the list of the preliminary media annotations. This initial selection is based on general match between the state of the user and the media and the available annotations. The next step, shown in FIG. 13, refines the selected initial annotations.

FIG. 13 shows a high-level block diagram of a system for refinement of the selected annotations. That is, FIG. 13 shows a final stage of further filtering of plausible annotations to refine the match to the user's immediate state. As shown, a system 1300 includes plausible annotations 1302, an inference/reasoning engine 1304, user's information database 1306, a matcher 1308, and current annotation candidates 1312. The inference/reasoning engine 1304 optimizes the plausible annotations 1302 based the user's information database 1306. The current annotation candidates generated in this stage matches the user's immediate state by the matcher 1310.

The set of flows described above in FIGS. 10-13 is executed every pre-set period of time to refresh the user's and the media's state and to update the list of optimal annotations for the new segment of the media.

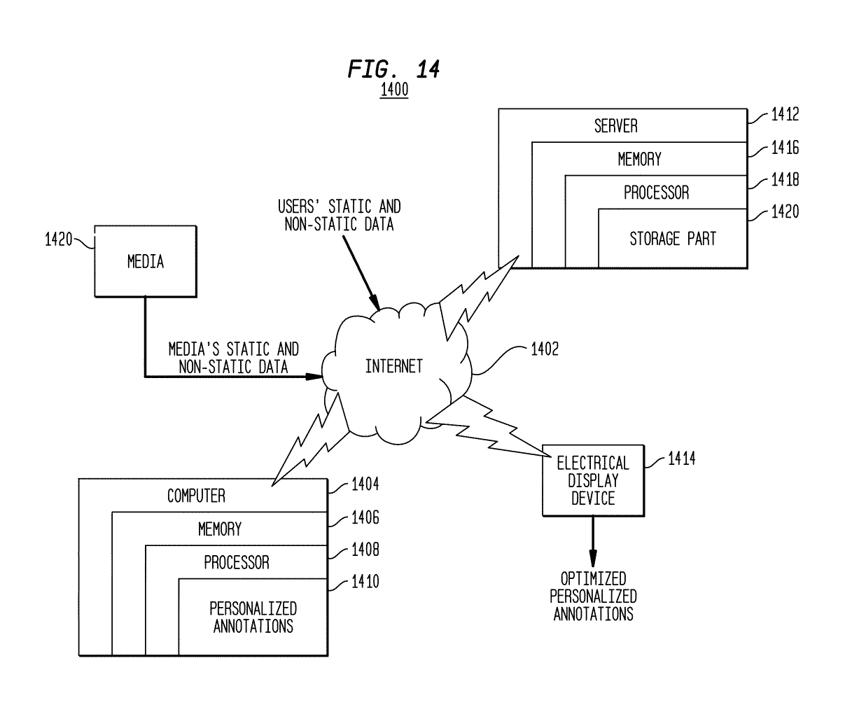

In the exemplary embodiments, optimized personalized media annotations are computed and inferred by running software either on the consumer devices (e.g., one or more computers) or servers or on remote third party servers. FIG. 14 shows a block diagram of a computer system for generating the optimized personalized annotations using fluid user models. As shown, system 1400 includes Internet 1402, intranet (not shown), or other computer network, which are used for communication between or among various electronic devices and computers of the system 1400. The system 1400 further includes an annotation computation machine or computer 1404, a storage sever 1412, a display device 1414, and a media 1420. The annotation computation machine or computer 1404 has a memory 1406 which stores user's personalization data, and one or more processors 1408 connected to the memory 1406 wherein the one or more processors 1408 can execute the user's personalization data stored in the memory 1406. The memory 1406 may be used for storing the user's personalization data, for storing media metadata and information, for system support, and the like. The one or more processors 1408 also might execute processing on the media information stored in the memory 1406. The computer 1404 may also collect the user's personalization data from the medium 1420 that may present various videos to one or more users through the Internet 1402. In this case the user's personalization data captured by the computer 1404 is analyzed by the computer 1404 to produce the user's personalization information. Based on the produced user's personalization information, the computer 1404 may compute and generate an annotation.

In one exemplary embodiment, there may be multiple computers 1404 that collect the user's personalization data from one or more users as they observe a video or videos.

Once the user's personalization data has been collected, the computer 1404 may upload information to a storage server 1412, based on the user's personalization data from one or a plurality of users who observe the video or videos. The computer 1404 may communicate with the storage server 1412 over the Internet 1402, intranet, some other computer network, or by any other method suitable for communication between two computers. In some embodiments, the computer functionality of the storage server 1412 may be embodied in the computer 1404.

The storage server 1412 includes a memory 1416 which stores instructions, data, help information and the like, and one or more processors 1418 connected to the memory 1416 wherein the one or more processors 1418 can execute the user's personalization data. The memory 1416 may be used for storing the user's personalization data and the simulated user's personalized annotations, for storing media metadata, for system support, and the like, which are stored in a storage part 1420. The storage server 1412 may have a connection to the Internet 1402 to enable the user's personalization data to be received by the computer 1404. Further, the storage server 1412 may communicate with an electronic display device 1414 through the Internet 1402 that may convey information to a user. The computer 1404 may use the Internet 1402, or other computer communication method, to obtain the user's personalization information. The storage server 1412 may receive the user's personalization data collected from a plurality of users from the computer or computers 1404, and may aggregate the user's personalization information on the plurality of users who observe the video on the medium 1420.

The storage server 1412 may process the user's personalization data or aggregated the user's personalization data gathered from a viewer or a plurality of users to produce annotation information about the viewer or plurality of users. In one exemplary embodiment, the storage server 1412 may obtain the personalization data from the computer 1404. In this case the personalization data captured by the computer 1404 is analyzed by the computer 1404 to produce the personalization information for uploading. Based on the personalization information produced, the storage server 1412 may compute and generate an annotation.

In at least one exemplary embodiment, a single computer may incorporate the medium, server and simulated annotations. The system 1400 may include computer program product stored on a non-transitory computer-readable medium for facial analysis, the computer program product comprising: code for collecting user's data including user's static and non-static data, such as user's name and age, interests, skills and knowledge, goals and plans, preferences and dislikes, schedule, to-do list, history, context, activities, mood, multi-tasking, behavior, interactions with the system, etc.; code for collecting media data including media static and non-static data, such as, media metadata that capture known facts of the media such as a genre, elements of a media presentation (e.g., a plot, or a segment of a video), other known facts, a map of the media such as a table of contents or scene descriptions, transient data of the media that includes sensor data captured from the media in real time including current sound track for the media, visual snippets of the media, or the like; code for providing tagged annotations; code for computing and inferring a state of a user and a state of a media; and code for matching generated annotations to the immediate user's state; code for optimizing the generated annotations; code for communicating between the media, computer system, server, and display devices. The system 1700 may include a memory for storing the personalization data along with one or more processors attached to the memory wherein the one or more processors are configured to: collect the user's static and non-static data; collect the media static and non-static data; provide tagged annotations; compute/infer a state of a user and a state of a media; match the generated annotations; and optimize the generated annotations.

The described embodiments support a fluid user model, which includes a collection of user interests. Some of these interests are relatively static while others are highly time and context sensitive and should be derived (e.g., inferred) in real time using knowledge about the user's immediate environment and recent history. At any given time during the watching of the video, the user's primary interest can shift and as a result the optimal annotations that may be presented shift as well.

The system that controls the fluid user model contains inference engines that use inference rules to infer plausible interests based on the diverse information available about the video, the user and their interaction.

The described embodiments can be applied to a variety of mobile apps including context sensitive reminder services and augmented reality. In these cases, the video is replaced with “reality” itself and the application provides the user with additional information (“annotations”) that increases the user's productivity and fun.

The described embodiments describe a novel approach to constructing and using models (metadata) for that characterize the users and the media, which are inherently dynamic and sensitive to the moment-by-moment interests and context of the user. Note that the applicability of the approach and mechanism goes beyond media augmentations to application domains such as augmented reality, gaming and education.

The described embodiments may be executed on one or more processors on one or more computer systems. Embodiments may include various forms of distributed computing; client/server computing, and cloud based computing. Further, it will be understood that for the flow diagrams in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flow diagram illustrations depict methods, apparatus, systems, and computer program products. Each element of the block diagrams and flow diagram illustrations, as well as each respective combination of elements in the block diagrams and flow diagram illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which may be generally referred to herein as a “circuit,” “module,” or “system.”

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A: X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “engine”, “model” or the like is generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments of the present invention have been described with respect to processes of circuits, including possible implementation as a single integrated circuit, a multi-chip module, a single card, or a multi-card circuit pack, the present invention is not so limited. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

No claim element herein is to be construed under the provisions of 35 U.S.C. §112, sixth paragraph, unless the element is expressly recited using the phrase “means for” or “step for.”

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method, comprising the steps of:
playing a media presentation to a user,
capturing user data and media data, while the media presentation is played;
providing tagged annotations of the media to the user,
simultaneously computing a state of the user and a state of the media based on the user data, the media data and the tagged annotations by inferring and reasoning engines, wherein the state of the user is computed based on a fluid user model providing a fluid user profile in which user's interests are shifted over time as the user receives the media presentation;
inferring preliminary annotations based on the computed state of the user, the computed state of the media, the tagged annotations, and interaction by the inferring and reasoning engines;
generating relatively optimized plausible annotations from the preliminary annotations for a given time interval by an optimization engine; and
updating the tagged annotations of the media with the optimized plausible annotations for the user,
repeating the steps of the computing, the inferring, the generating, and the updating as the user receives the media presentation.

2. The method of claim 1 further comprising a step of collecting at least one of express interests and moods by the user before the step of the playing the media presentation.

3. The method of claim 1 further comprising a step of storing the updated tagged annotations in a memory or a server as part of the media for later use.

4. The method of claim 1, further comprising a step of sharing the updated tagged annotations with the user's social network.

5. The method of claim 1, further comprising a step of displaying the updated tagged annotations on a display device.

6. The method of claim 7 wherein the display device is a device for a mobile application including at least one of a smart TV, a laptop, a tablet, and a smart phone.

7. The method of claim 1 further comprising a step of capturing a user's feedback either explicit through an interface or implicit by user's viewing behavior.

8. The method of claim 1 wherein the inferring and reasoning engines are processors executing corresponding inferring and reasoning algorithms.

9. The method of claim 1 wherein the optimization engine is a processor optimizing based on a predetermined optimization algorithm.

10. The method of claim 1 wherein the step of the computing the state of the user includes a step matching the state of the user to an immediate state of the user by a matcher;

11. The method of claim 10 wherein the matcher is a processor.

12. The method of claim 1 wherein the step of the inferring the preliminary annotations includes a step of matching the inferred preliminary annotations an immediate state of the user by a matcher.

13. The method of claim 1 wherein the step of the optimizing the plausible annotations includes a step of matching the plausible annotations selected from the preliminary annotations to an immediate state of the user by a matcher;

14. The method of claim 1 wherein the fluid user model includes a collection of interests of the user from the user data collected at a time when the user is viewing the media presentation, wherein the user's interests are at least one of a relatively static interest and a time dependent interest.

15. The method of claim 14 wherein the user's time dependent interests are inferred in real time using knowledge about user's general disposition, taste, past behavior, immediate environment and recent history.

16. The method of claim 1 wherein the fluid user model includes a list of inference rules employed to compute and monitor a user's attention and a user's current attention level based on a variety of time dependent parameters including at least one of the user's activities, mood, emotion, level of attention and recent history.

17. The method of claim 16 wherein the inference rules specify the conditions to select annotations for display to the user.

18. The method of claim 1 wherein the step of the computing the state of the user is based on the user data and the tagged annotations of the media.

19. The method of claim 18 wherein the step of the computing the state of the user includes a step of matching the user's state to a user's immediate state.

20. The method of claim 1 wherein the step of the computing the state of the media is based on the media data.

21. The method of claim 1 wherein the user data includes static data and non-static data of the user.

22. The method of claim 21 wherein the user's static data includes at least one of interests and context.

23. The method of claim 21 wherein the user's non-static data includes one or more of current context, current mood, current energy level, current activities, recent history, longer term history, future plans, behavior, interactions with the system, transient or opportunistic interests, and user's attention level as a result of current activities.

24. The method of claim 1 wherein the media data includes media static data and media non-static data.

25. The method of claim 24 wherein the media static data includes media metadata capturing one or more facts comprising genre, elements of the media presentation, database facts, and a map of the media such as a table of contents or scene descriptions.

26. The method of claim 24 wherein the media non-static data includes a current sound track for the media and visual snippets of the media.

27. The method of claim 24 wherein the media non-static data is sensor data.

28. The method of claim 1 wherein the media is a mobile application of at least one of a smart TV, PC, laptop, tablet, smart phones and personal digital assistant.

29. The method of claim 1 wherein the updated tagged annotations include texts, images, graphics, video, and audio.

30. The method of claim 1 wherein the state of the user includes one or more of interests, preferences, context, mood, attention level, and transient parameters of the user.

31. The method of claim 1 wherein the state of the media includes attributes that help pinpoint parts of the time dependent media including scenes, music score, clock time, screenplay, music score, shooting locations, casting, and production of the media.

32. The method of claim 1 wherein the updated tagged annotations for the user are displayed in a fashion including one or more of a viewing screen of the media, on a secondary screen and stored in a file for viewing by the user at a later time.

33. The method of claim 1 wherein the fluid user model is an immersive model.

34. A computer system for media annotations comprising:
a memory for storing static and non-static media data and static and non-static user data;
at least one processor attached to the memory wherein the at least one processor is configured to:
collect static user data and static media metadata, while a media presentation is played on a media to a user;
capture non-static user data and non-static media data;
provide tagged annotations;
simultaneously compute a state of the user and a state of the media in real time;
generate preliminary annotations based on the computed state of the user, the computed state of the media, and the tagged annotations;
match plausible annotations selected from the preliminary annotations to an immediate state of the user;
optimize the plausible annotations for a given time interval;
update the tagged annotations with the optimized plausible annotations for next media presentation for the user; and
display the updated tagged annotations on a display device,
wherein the state of the user is computed based on a fluid user model that generates a fluid user profile, in which user's interests are shifted over time as the user goes through the media.
